(19) United States
(12) Patent Application Publication
(10) Pub. No.: US 2025/0370833 A1
(43) Pub. Date: Dec. 4, 2025

(54) INPUT VALIDATION IN TASK-ORIENTED SYSTEMS

(71) Applicant: INTERNATIONAL BUSINESS MACHINES CORPORATION, Armonk, NY (US)

(72) Inventors: Sampath DECHU, Acton, MA (US); Robert Leslie YATES, Arlington, MA (US); Allen Vi Cuong CHAN, Markham (CA); Sebastian CARBAJALES, Mississauga (CA)

(21) Appl. No.: 18/675,503

(22) Filed: May 28, 2024

(51) Int. Cl. G06F 9/54; G06N 3/044; G06N 3/0464

(52) U.S. Cl. CPC G06F 9/547; G06N 3/044; G06N 3/0464

(57) ABSTRACT

Computer implemented methods, systems, and computer program products include program code executing on a processor(s) identifies, in a specification for a task API, one or more operations comprising a workflow, where each operation comprises obtaining specific data to fill a slot to call the task API, where a final task of the workflow comprises a call to the task API. The processor(s) generates, for each slot, resolution and validation rules. The processor(s) generates a gateway comprising the validation rules. Generating the gateway includes the processor(s) connecting the resolution and validation rules to the gateway between the conversational system and a dialogue manager. The processor(s) applies the gateway to resolve each utterance obtained via the conversational system to a slot. In applying the gateway, the processor(s) determines whether to utilize the dialogue manager to generate a prompt to gather a new input or whether to execute the task API.

### BACKGROUND

The present invention relates generally to the field of data machine learning and in particular to a method for deploying workflows to increase the flexibility of systems including task-specific conversational systems.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

Natural language understanding (NLU) uses deep learning to extract meaning and metadata from unstructured text data. For example, NLU can be used to extract categories, classification, entities, keywords, sentiment, emotion, relations and/or syntax from text. NLU capabilities can be implemented as a machine learning system that can include a neural network (NN). NLU technologies can utilize supervised, semi-supervised, or unsupervised deep learning through a single-or multi-layer NN to classify data. The deep learning capabilities use the NN to identify and weight connections between data points. The use of deep learning, including in NLU, is understood as a form of artificial intelligence. A subset of NLU is natural language processing (NLP). NLP is a subfield of AI and computer science that focuses on the tokenization of data and specifically, the parsing of human language, whether spoken or text, into its elemental pieces.

Large language models (LLMs) are deep learning models that are pre-trained on vast amounts of data. Transformer LLMs refer to LLMs that are capable of unsupervised training and can learn to understand basic grammar, languages, and knowledge. The underlying transformer for a transformer LLM is a set of neural networks that consist of an encoder and a decoder with self-attention capabilities. The encoder and decoder extract meanings from a sequence of text and understand the relationships between words and phrases in it. Unlike earlier recurrent neural networks (RNN) that sequentially process inputs, transformers process entire sequences in parallel. In addition to utilizing CPUs to train LLMs, data scientists can also use GPUs for training transformer based LLMs, significantly reducing the training time.

Conversational artificial intelligence (AI) is a type of AI that can simulate human conversation. It is made possible by NLP and NLU, which are fields of AI that enable computers to understand and process human language. Certain conversational AI can be referred to as conversational systems or dialogue systems and these systems, based on speech-based inputs, will call application programming interfaces (APIs) to fulfill various tasks. The inputs from the conversational system that call these APIs are referred to as “slots.” Hence, in a given workflow, a conversational system (e.g., a task-specific conversational system) calls an API to fulfill a task and in order for the API to fulfill the task, the conversational system initially acquires information which are inputs for the task.

### SUMMARY

Shortcomings of the prior art are overcome, and additional advantages are provided through the provision of a computer-implemented method for resolving and validating data to pass from a conversational system to an application programming interface. The method can include: identifying, by one or more processors, in a specification for a task API, one or more operations comprising a workflow, wherein each operation comprises obtaining specific data to fill a slot to call the task API, wherein a final task of the workflow comprises a call to the task API; generating, by the one or more processors, for each slot, resolution and validation rules; generating, by the one or more processors, a gateway comprising the resolution and validation rules, wherein the generating the gateway comprises connecting the resolution and validation rules to the gateway between the conversational system and a dialogue manager; and applying, by the one or more processors, the gateway to resolve each utterance obtained via the conversational system to a slot, wherein the applying comprises determining whether to utilize the dialogue manager to generate a prompt to gather a new input or whether to execute the task API.

Shortcomings of the prior art are overcome, and additional advantages are provided through the provision of a computer program product for resolving and validating data to pass from a conversational system to an application programming interface. The computer program product comprises a storage medium readable by a one or more processors and storing instructions for execution by the one or more processors for performing a method. The method includes, for instance: : identifying, by the one or more processors, in a specification for a task API, one or more operations comprising a workflow, wherein each operation comprises obtaining specific data to fill a slot to call the task API, wherein a final task of the workflow comprises a call to the task API; generating, by the one or more processors, for each slot, resolution and validation rules; generating, by the one or more processors, a gateway comprising the resolution and validation rules, wherein the generating the gateway comprises connecting the resolution and validation rules to the gateway between the conversational system and a dialogue manager; and applying, by the one or more processors, the gateway to resolve each utterance obtained via the conversational system to a slot, wherein the applying comprises determining whether to utilize the dialogue manager to generate a prompt to gather a new input or whether to execute the task API.

Shortcomings of the prior art are overcome, and additional advantages are provided through the provision of a system for resolving and validating data to pass from a conversational system to an application programming interface. The system includes: a memory, one or more processors in communication with the memory, and program instructions executable by the one or more processors via the memory to perform a method. The method includes, identifying, by the one or more processors, in a specification for a task API, one or more operations comprising a workflow, wherein each operation comprises obtaining specific data to fill a slot to call the task API, wherein a final task of the workflow comprises a call to the task API; generating, by the one or more processors, for each slot, resolution and validation rules; generating, by the one or more processors, a gateway comprising the resolution and validation rules, wherein the generating the gateway comprises connecting the resolution and validation rules to the gateway between the conversational system and a dialogue manager; and applying, by the one or more processors, the gateway to resolve each utterance obtained via the conversational system to a slot, wherein the applying comprises determining whether to utilize the dialogue manager to generate a prompt to gather a new input or whether to execute the task API.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 is an illustration of an issue in conversational systems that is addressed by various aspects of the present disclosure;

FIG. 3 is an illustration of elements of a system that can be utilized to perform various aspects of the present disclosure;

FIG. 4 is a workflow that provides an overview of various aspects performed by the program code (executing on one or more processors) in some embodiments of the present disclosure;

FIG. 5 is a workflow that provides an overview of various aspects performed by the program code (executing on one or more processors) in some embodiments of the present disclosure; and

FIG. 6 is a workflow that provides an overview of various aspects performed by the program code (executing on one or more processors) in some embodiments of the present disclosure;

### DETAILED DESCRIPTION

The computer-implemented methods, computer program products, and systems described herein include computer code executing on one or more processors that generates and deploys workflows to increase the flexibility of (e.g., task-specific) conversational systems. To increase the flexibility in this manner, program code in various examples herein provides a layer, which can be understood as a smart layer, on top of an existing API, which is called by the conversational system in which these examples are implemented, to identify and obtain missing inputs in dialog workflows. Passing (specific) data from a conversational system to an API can be referred to as slot-filling. Various aspects of some examples include: 1) program code to generate workflows in conversational systems to obtain data to pass to APIs; and/or 2) program code to determine which (generated) workflow to call based on a state of a conversation in a conversational system. The examples herein can include program code that utilizes an LLM to generate a prompt. In some examples, the program code obtains inputs from users to generate decision logic for a workflow. Although various examples herein illustrate how the utilization of the disclosed aspects resolve and pass data from a conversational system to APIs, one of skill in the art will appreciate that the various techniques described herein, in particular, the use of LLMs to pass slot-filling data to APIs, can be integrated into various systems in order to increase workflow efficiency and to preserve data integrity for inputs into APIs and other receptors of data.

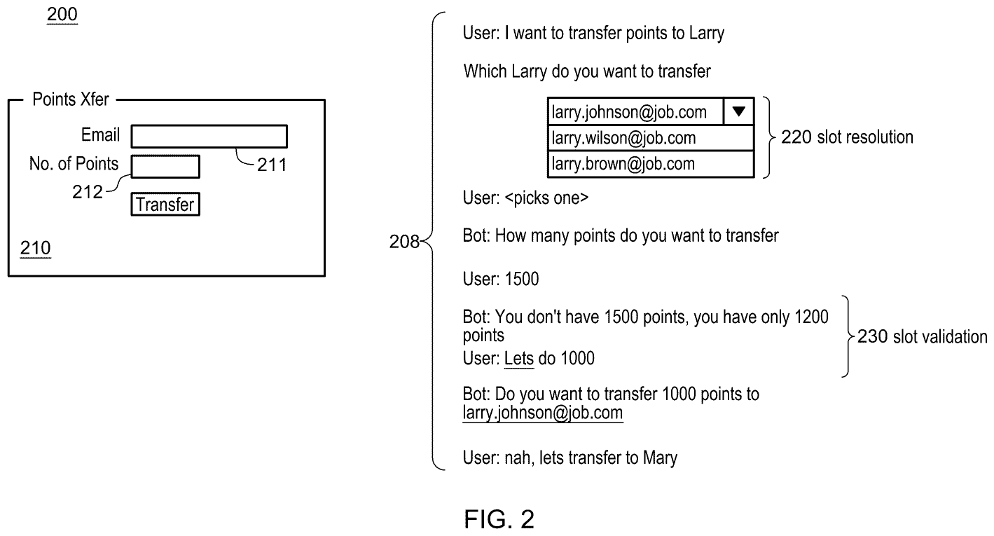

The examples herein are directed to practical applications and provide significant benefits over existing approaches. These benefits are directed to these practical applications. LLMs, including chat LLMs, interact with users to gather data to execute agents including APIs. However, the APIs utilize specific data to execute processes and the slot-filling of the API data can be a challenge. As illustrated in additional detail in FIG. 2, the ambiguity of natural language responses can provide various challenges in providing APIs with the slot-filling data to continue and/or initiate a workflow. Because of the ambiguities (including the variety) in natural language responses, a present approach is to utilize a digital assistant to resolve and validate the inputs provided by a human user by calling enterprise systems of records iteratively and further conversing with user to disambiguate. This iterative approach can be disruptive to workflow efficiencies and can create a bottleneck as the API cannot utilize these data until the data is resolved and validated (e.g., slot resolution and validation). Slot resolution utilizing existing approaches can require multiple user interactions with a user interface (UI). In these approaches, the UI will remain in “conversation” with the user until all the slot values resolved, validated, and confirmed, and only then can actions be initiated. Existing approaches do not provide a capability for bootstrapping slot resolution and validation processed for API calling agents from an application UI designed by a user. To address this issue, the examples herein include various aspects of a slot resolution and validation proxy, in which program code executing on one or more processors provides slot-filling (resolved and validated) data to APIs from conversational or dialogue systems.

The slot resolution and validation (SRV) proxy described herein acts as middleware between a conversational UI and an API utilized to fulfill a task (which can be referred to as a task API). Thus, issues between a UI and API can be resolved quickly, flexibly, and efficiently, effectively eliminating bottlenecks in current approaches. The examples herein (which include an element referred to as an SRV proxy) can include program code that: 1) enables input slots for a task API to be gathered, resolved and validated by an AI assistant (even when an end user provides the slot values in arbitrary order); 2) supports slot validation logic across slots with consideration for temporal issues and/or frameworks; 3) executes validation and resolution logic progressively as an end user conversation progresses with Al assistant; 4) enables customizations by a developer to enhance the slot resolution and validation logic with additional rules and API calls based on business requirements; and/or 5) integrates into long duration slot-filling dialogue, resolution, and validation logic execution for any type of task API.

The examples herein are inextricably tied to computing at least because they address an issue that is unique to computing: slot resolution and validation for data provided from conversational systems to APIs so that APIs can accomplish one or more tasks in a workflow. As explained above, there are latencies and bottlenecks when providing data to APIs via conversational systems because of the ambiguity and variety in which data is provided. However, to accomplish a task, an API utilizes specific data, which using current approaches, may not be provided or otherwise available and/or is not provided efficiently. The examples herein provide a middleware solution that is situated in a technical environment between a conversational system and an API. Program code comprising the middleware solution resolves and validates data slotted into the API so that the API can accomplish the desired task. This middleware, which can also be understood as a proxy API, is communicatively coupled to the conversational system and an API to enable the resolution and validation of data. The examples herein are also inextricably tied to computing because they can be viewed as an enhancement to an LLM that addresses a known shortcoming of LLMs. LLMs themselves are inextricably tied to computing (as are APIs) and thus, program code executing one or more processors that address known issues and provide improvements to LLMs and APIs are necessarily also inextricably tied to computing. The examples herein enable the optimization of LLMs and APIs in a manner that reduces the amount computing resources utilized to determine slots values for an API call, resolve and validate data from a conversational system to fill these slots, and call and complete a task in a workflow.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

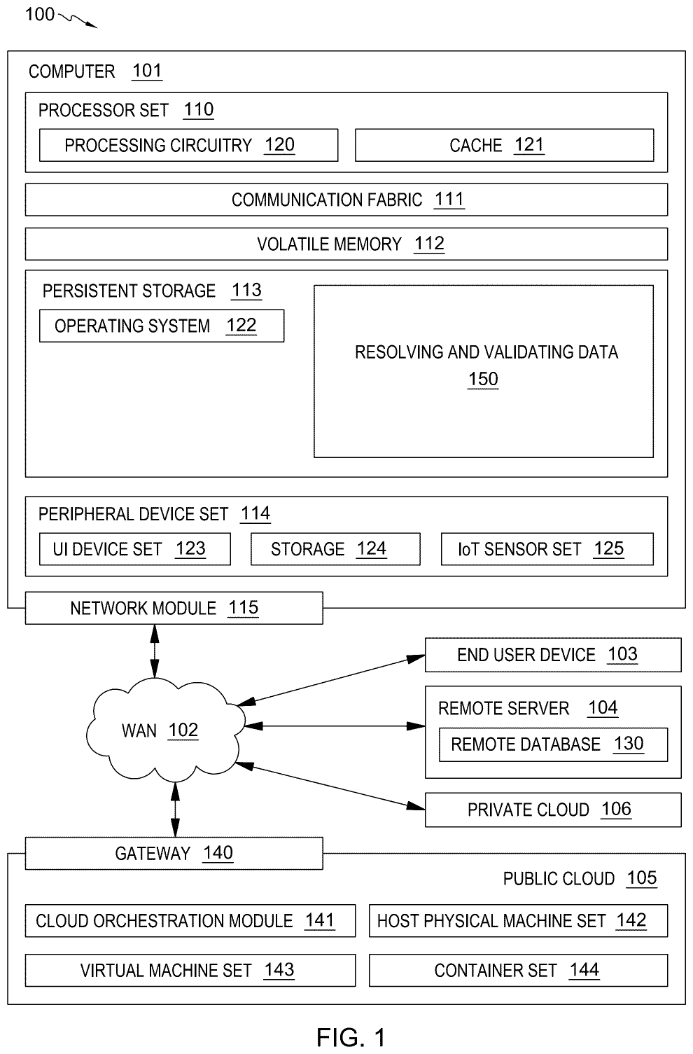

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for resolving and validating data 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Neural networks, which are utilized in certain of the examples herein, refer to a biologically inspired programming paradigm which enables a computer to learn from observational data. This learning is referred to as deep learning, which is a set of techniques for learning in neural networks. Neural networks, including modular neural networks, are capable of pattern recognition with speed, accuracy, and efficiency, in situations where data sets are multiple and expansive, including across a distributed network of the technical environment. Modern neural networks are non-linear statistical data modeling tools. They are usually used to model complex relationships between inputs and outputs or to identify patterns in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in image recognition, speech recognition, and natural language processing. Neural networks can model complex relationships between inputs and outputs to identify patterns in data, including in images, for classification. In the examples herein, the program code can utilize CNNs and/or RNNs to resolve and validate data to provide these data to an API (e.g., slot-filling).

In certain embodiments of the present invention the program code utilizes a CNN. CNNs are so named because they utilize convolutional layers that apply a convolution operation (a mathematical operation on two functions to produce a third function that expresses how the shape of one is modified by the other) to the input, passing the result to the next layer. The convolution emulates the response of an individual neuron to visual stimuli. Each convolutional neuron processes data only for its receptive field. It is generally not practical to utilize general (i.e., fully connected feedforward) neural networks to process data rich objects, as very high number of neurons would be necessary, due to the very large input sizes associated with larger files. Utilizing a CNN addresses this issue as it reduces the number of free parameters, allowing the network to be deeper with fewer parameters, as regardless of the file size, the CNN can utilize a consistent number of learnable parameters because CNNs fine-tune large amounts of parameters and massive pre-labeled datasets to support a learning process. CNNs resolve the vanishing or exploding gradients problem in training traditional multi-layer neural networks, with many layers, by using backpropagation. Thus, CNNs can be utilized in large-scale recognition systems, giving state-of-the-art results in segmentation, object detection, and object retrieval.

In certain embodiments of the present invention the program code utilizes an RNN. An RNN is a class of NN where connections between units form a directed cycle to exhibit dynamic temporal behavior. Unlike feedforward NNs, RNNs can use their internal memory to process arbitrary sequences of inputs. For this reason, current applications of RNNs include unsegmented data recognition, connected handwriting recognition, and speech recognition. These types of insights are useful in resolving and validating data obtained via a conversational system.

An LLM is a deep learning model. Program code in the examples herein can implement a deep learning model in various forms such as by a neural network (e.g., a CNN, an RNN); LLMs are generally implemented using an NN. In some examples, a deep learning model includes multiple layers, each layer comprising multiple processing nodes. In some examples, the layers process in sequence, with nodes of layers closer to the model input layer processing before nodes of layers closer to the model output. Thus, layers feed to the next. Interior nodes are often “hidden” in the sense that their input and output values are not visible outside the model. In these examples, the program code can utilize NNs to validate and resolve data obtained via a conversational system to provide these data to an API.

FIG. 2, which was mentioned above, illustrated a process of a slot-filling for a task-oriented conversational (also referred to as dialogue) system. In this example, the slot-filling is done to transfer an object called a “point” from one user to another. This example is provided to illustrate of how a dialogue or conversational system can provide data to an API such that the API can trigger and/or complete a process. The process and the slot-filling illustrated in this figure is not provided to suggest any limitations. In FIG. 2, a form 210 is provided which includes the slots (fields) relevant to the task of transferring points. The data which would be provided to an API, based on filling the slots, for the point transfer, is an email address 211 and a number of points 212. There is a transfer button 213 to effect the transfer. The form 210 can accept these entries in a straightforward manner, for example, it can be a graphical user interface (GUI). However, when a conversational system is performing the slot-filling, the process can be more complicated. As illustrated on the right side of FIG. 2, a conversation 208 between a user and a bot occurs such that the bot can fill the slots, email address 211 and number of points 212. In order to resolve 220 the email address 211 slot, the bot requests that the user select, in a UI 213, an email address to show which “Larry” the user is transferring the points to. Additionally, the bot validates 230 the number of points. However, after the slots are resolved and validated, the user states, “Nah, lets transfer to Mary,” which creates an ambiguity. The conversation 208 in FIG. 2 is reproduced below, including when the program code provides a UI for the user to select an option to clarify what was stated.

User: I want to transfer points to larry

Bot: Which Larry do you want to transfer

User: <picks one>

Bot: How many points do you want to transfer

User: 1500

Bot: You don't have 1500 points, you have only 1200 points

User: Lets do 1000

Bot: Do you want to transfer 1000 points to larry.johnson@job.com

User: nah lets transfer to Mary

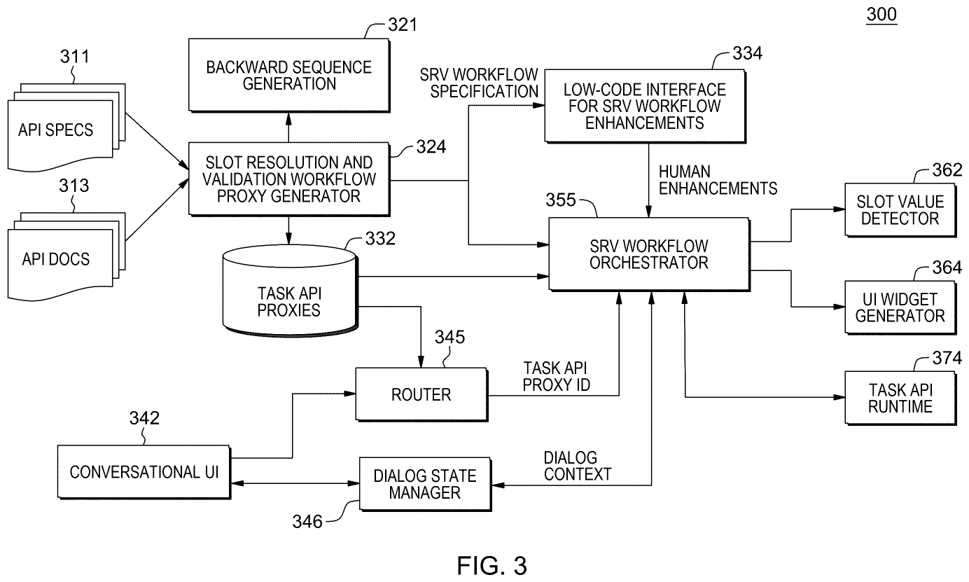

FIG. 3 illustrates a computing system 300 in which various aspects of the present

invention have been implemented. FIG. 3 illustrates how program code generates a slot resolution and validation (SRV) proxy 332 and how this proxy 332 fulfills API tasks in task-oriented dialogue-systems by sitting between a conversation UI 342 and a task API, which the program code calls (e.g., task API runtime 374) to fulfill a task. Portions of FIG. 3 which can utilize existing systems include program code that performs backward sequence generation 321, program code that detects slot values, referred to herein as a slot value detector 362, and program code that generates UI widgets, referred to herein as a UI widget generator 364. Various aspects described as well as illustrated herein can utilize these existing systems to perform the workflows described herein.

The system 300 includes program code executed on one or more processors which generates customizable slot resolution and validation workflows 324 from API specifications 311 and/or API documents 313. Program code obtains (e.g., ingests) API specifications and/or API documents to determine the data (e.g., slots) the conversational system will fill to enable the API to accept these data to perform a task. The program code which generates customizable slot resolution and validation workflows 324 can orchestrate these workflows for multi-turn, out-of-order slot-filling in task-oriented dialogue systems for API tasks. The program code 324 generates each slot resolution and validation slot process from backward sequence API tasks, which the program code 324 can utilize backward sequence generation 321 processes, including existing third-party options, to generate. Based on the information ingested and analyzed by the program code which generates customizable slot resolution and validation workflows 324, this program code can generate task API proxies 332. In some examples, the slot resolution and validation (SRV) proxy (e.g., task API proxies 332) generated by the program code is a special workflow generated from API specifications and documentation that adheres to Business Process Model and Notation (BPMN) specification standards. The program code generates task API proxies 332, which can be referred to as slot resolution and validation (SRV) proxies, to sit between a conversational UI 342 and a task API, the task API runtime 374; the task API runtime 374 is called by the program code to fulfill a given task.

The program code generates SRV (task) API proxies 332 from API specifications 311 and/or API documents 313 obtained by the program code. The API proxies 332 enable a task API (e.g., task API runtime 374) to be called from a conversational UI 342 by engaging with an end user in multi-turn out-of-order slot-filling conversation. Program code in these examples can orchestrate slot resolution and validation workflows 355 by gathering (validated) inputs for a task API in a conversational experience.

In some of the examples herein, program code gathers, resolves, and validates input slots of task APIs even when an end user provides the slot values in an arbitrary order by engaging in a multi-turn conversation with an Al assistant. In some examples, the program code validates logic across slots (e.g., start time should be before end time) throughout the conversation. As illustrated in FIG. 3, the program code 324 gathers input slots of task APIs (from the API specifications 311 and/or the API documents 313) and resolves and validates an AI assistant (assisted by an SRV (task) API proxy 332) when an end user provides the slot values in arbitrary orders, based on the engaging in a multi-turn conversation with the Al assistant.

As illustrated in FIG. 3, the task API proxy 332, generated by the program code 324, which can reference backward sequence generation functionality 321, is communicatively coupled to a router 345, which enables a conversational UI 342 to interact with program code comprising an SRV workflow orchestrator 355. The router 345 can communicate a task API proxy identifier to the program code of the SRV workflow orchestrator 355. The router 345 can be understood as a conversational UI router and the router 345 can determine if utterances are API tasks and program code comprising a task-oriented dialogue system (TODS) can mark the conversation as entering API task scope (meaning that utterances could potentially fill slots). The program code of the SRV workflow orchestrator 355 can interact with a slot value detector 362 and a UI widget generator 364 to resolve and validate inputs (e.g., utterances) to provide to the task API runtime 374. Based on the SRV workflow specification generated by the SRV workflow proxy generator 324, the program code can continuously update the SRV workflow orchestrator 355 with low-code interface SRV enhancements 334, including human enhancements.

Low-code is an application development method that elevates coding from textual to visual. Thus, rather than utilizing a technical coding environment, low-code operates in a model-driven, drag-and-drop interface. In the examples herein, the low-code interface enhancements 334 (which can include human enhancements), are customizations that can be introduced by a software developer to enhance the slot resolution and validation logic with additional rules and API calls based on business requirements. In some examples, the workflow generated by the slot resolution and validation workflow proxy generator 324 can include various types of tasks, including but not limited to human tasks, system tasks, and/or decision tasks. These tasks are accomplished to achieve a specific outcome. During the workflow, these tasks can occur in parallel or sequentially. The workflows generated by the program code are stateful and inherently support long running tasks. In examples where the workflow generated by the program code adherences to a BPMN standard, the program code can generate a workflow that can be imported into a low-code workflow authoring tool, via a low-code interface 334 so that users can add additional logic in a low-code experience to enhance the workflow (e.g., including the human enhancements).

In FIG. 3, the conversational UI 342 can reference a dialogue state manager 346 to obtain and provide dialogue context from/to the SRV workflow orchestrator 355. As the dialogue progresses, the program code can execute validation and resolution logic progressively as the end user conversation progresses with an AI assistant (e.g., based on the SRV workflow orchestrator accessing the UI widget generator 364). The program code can handle long duration slot-filling dialogue and support long-running resolution and validation logic execution for task APIs.

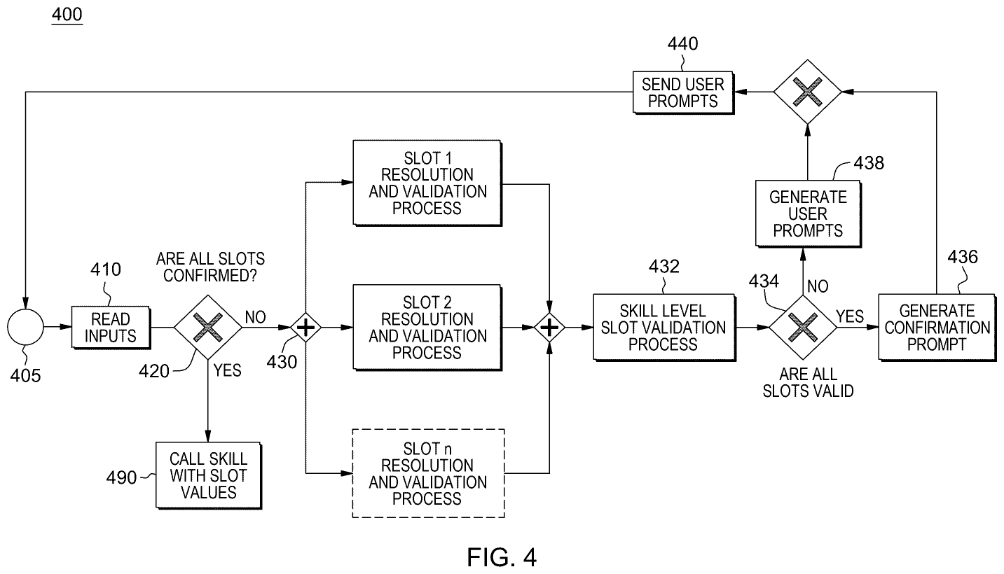

FIG. 4 provides a high-level example of output generated in various examples herein. FIG. 4 can be understood in the context of an example in which a user wishes to utilize a conversational system, which calls an API, to transfer points to another user. The API task of transferring points is utilized in this example for illustrative purposes only and not to suggest any limitations to the type of task APIs for which the examples herein can provide resolution and validation. In an example, a user, Joe Smith, wishes to transfer 1500 points to another user, Bob. This example is explained below and then FIG. 4 is described.

In a conversational system, in order to effect a transfer (e.g., for a task API to commence and complete a transfer), a user named Joe Smith states, “I want to transfer 1500 points to Bob.” A task API called transfer_points can perform this task but there is certain data that the program code in the examples herein resolves and validates before the API can perform the task. The information needed by the API, includes: 1) a target user to which to transfer the points, target_user_id; 2) a source from which to transfer the points, in this case, the user making the request, source_user_id; and 3) a number of points, number_of_points. Based on the statement, “I want to transfer 1500 points to Bob,” the target user “Bob” was provided via user input, but this information alone is non-slot-fillable and the program code needs to resolve this input before the API can be called. Based on the statement having been made by an identified user, joe.smith@job.com, the email address is known by the program code for source_user_id but this information alone is non-slot-fillable and the program code needs to resolve this input before the API can be called. Finally, the user provided the number_of_points, but the program code must validate that these points are available from the source_user_id before the API can make the transfer. Once the program code in the examples herein has resolved and validated the slot-filling data to trigger the API, the program code can generate a confirmation message as output.

As aforementioned, the program code resolves the target_user_id as a user provided only the name “Bob.” To resolve this user, program code executing on one or more processors can search for the user (search_user). In this search, the input is a search string (search_string), and the outputs can be a name of the user (user_name) and an identifier for the user (user_id).

The program code also resolves the source_user_id. In this example, the program code can perform a “get” operation to obtain a user identifier for source_user_id (get_user_id). Based on the email address (email-id) as input, the program code can get the user identifier (user-id) as output.

The program code validates the number of points as for the transfer to be successful, at least the desired number of points to transfer must be available for transfer. To validate the transfer (e.g., of 1,500 points, transfer_points), the program code utilizes as input the target_user_id (non-slot-fillable), the source_user_id (non-slot-fillable), and the number of points (number_of_points), the latter should be less than the available number of points. The output of the transfer_points is a confirmation message (confirmation_message), but the program code can perform a “get” to get the number of points (get_number_of_points). The input for get_number_of_points is source-id (an identifier can also be input and this can be non-slot-fillable), and the output is the number of points, number_of_points (which is the available number of points for the source user).

Returning to FIG. 4, this workflow is somewhat circular until data to fill the slots of an API are resolved and/or validated by the program code. Once the slots are confirmed and/or validated, the program code can call a skill (e.g., a task API) (490). In this workflow 400, program code obtains inputs 405 (e.g., “I want to transfer 1500 points to Bob,”) and/or API specifications and/or documents. The program code can generate each slot resolution and validation subprocess from backward sequence API tasks. At later times in the process, the inputs 405 can include data that has been resolved and/or validated by the program code. However, program code can utilize one or more LLMs to perform NLP (and/or NLU) to determine the slots for the task-based API as well as to determine whether inputs that were obtained by the program code include data for all the slots. The program code can utilize one or more LLMs, including a conversational or chat LLM to assist in confirming slots in the API. For example, watsonx Orchestrate™ can be used to perform NLP while watsonx™ Assistant can be called by the program code when slots are confirmed by the program code to call a skill that can be utilized to advance the task of the task API or to call the task API itself. IBM Watson® and products referred to as watsonx are products of International Business Machines Corporation. IBM Watson® is a registered trademark of International Business Machines Corporation, Armonk, New York, US.

As illustrated in FIG. 4, the program code determines if the slots are confirmed (420). As aforementioned, the program code generates each slot resolution and validation subprocess from backward sequence API tasks, thus, if the slots are confirmed, the program code calls a skill (e.g., a task API) (490), if the program code determines that the slots are not confirmed, the program code identifies, confirms, and validates each slot (420). Illustrated in FIG. 4 is the program code confirming slots 1-n. The program code performs a skill (task) level validation process (to determine that the data can be utilized by an API so that the API can perform the task or skill) (432). The program code determines if the slots are valid (e.g., that enough points are available to transfer from a source to a target) (434). If a slot is valid, as noted in the example with the points transfer, the program code generates a confirmation prompt (436). If the program code determines that the slot is not valid, the program code (e.g., utilizing an LLM) can generate a prompt to the user (438). The program code sends a prompt to the user, which can either be a confirmation prompt or an additional prompt, depending on where in an iterative process of confirmation the program code is operating (440). User response to the prompts can become the input 405 for an additional iteration.

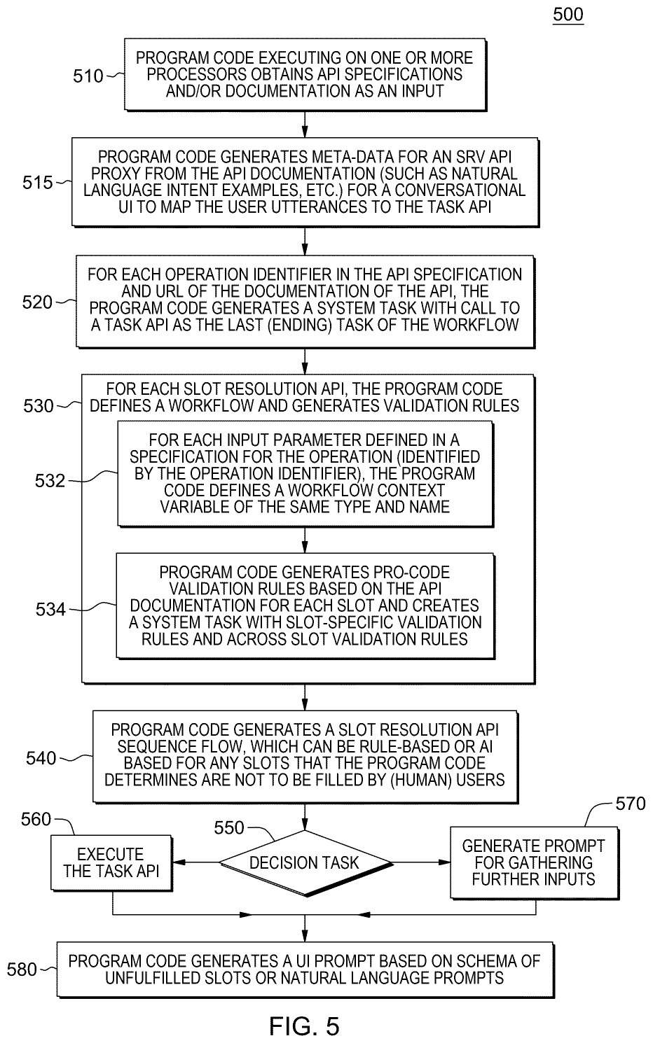

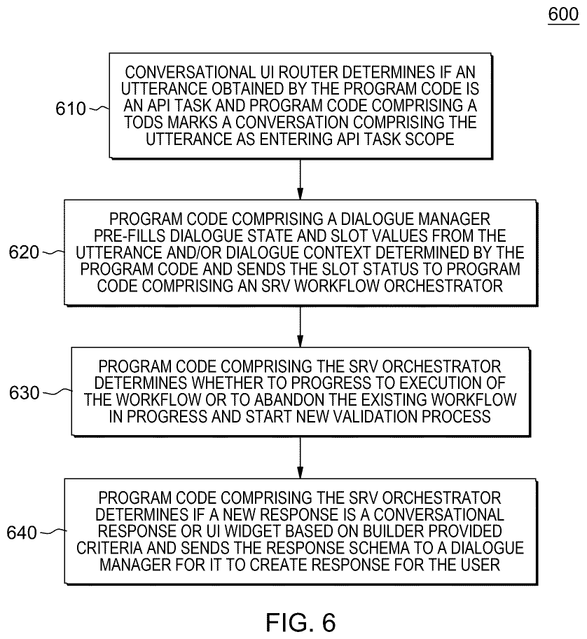

In order to resolve and validate data input into conversational systems such that these data can be provided to APIs and these APIs can execute tasks by filling slots with these data, some examples herein include program code executing on one or more processors that perform two aspects: 1) generating a slot validation and resolution API proxy from API specifications and documents (sec, e.g., FIG. 2); and 2) orchestrating slot validation and resolution workflows for multi-turn, out-of-order slot filling dialogue. FIG. 5 is a workflow 500 that illustrates this first aspect while FIG. 6 is a workflow 600 that illustrates the second aspect.

FIG. 5 illustrates a workflow where program code executing on one or more processors parses an (e.g., open) API specification document, including one available in an enterprise system interface, to identify a path. Referring to FIG. 5, in some examples herein, program code executing on one or more processors obtains API specifications and/or documentation as an input (510). The program code generates meta-data for an SRV API proxy from the API documentation (such as natural language intent examples, etc.) for a conversational UI to map the user utterances to the task API (515). For each operation identifier in the API specification and URL of the documentation of the API, the program code generates a system task with a call to a task API as the last (ending) task of the workflow (520). For each slot to fill to call the task API, the program code defines a workflow and generates validation rules (530). Specifically, for each input parameter defined in a specification for the operation (identified by the operation identifier), the program code defines a workflow context variable of the same type and name (532). The program code generates pro-code validation rules based on the API documentation for each slot and creates a system task with slot-specific validation rules and across slot validation rules (534). To generate this pro-code, the program code can utilize an existing approach or solution. The program code generates a slot resolution API sequence flow, which can be rule-based or AI-based for slots that the program code determines are not to be filled by (human) users (540). The program code connects all slot validation and resolution system tasks as parallel gateway (see, e.g., FIG. 4) connected to a decision task (550) to either execute the task API (560) or to generate prompt for gathering inputs from user (570) (e.g., an SRV API proxy). Both when resolving the decision task and when generating prompts to gather inputs, the program code utilizes the meta-data. When generating a prompt, the program code generates a UI prompt based on schema of un-fulfilled slots or natural language prompts (580).

FIG. 6 is a workflow 600 that illustrates program code executing on one or more processors orchestrating slot validation and resolution workflows for multi-turn, out-of-order slot filling dialogue. Task oriented dialogue and conversational systems can include various components, including but not limited to, NLU and/or NLP algorithms, a dialogue state tracker, a dialogue manager, and a natural language generator. The dialogue management system determines a system's next action at each step of a conversation based on a current dialogue state. For example, the dialogue management system can determine if the system should solicit additional information from the user, provide a response to a user, confirm an understanding of input provided by the user, and/or perform some other action. The workflow 600 of FIG. 6 illustrates how in the examples herein, a dialogue manager in a conversational system, specifically, a task-oriented dialogue and conversational system, engages iteratively with slot resolution and validation workflows once the program code of the dialogue manager determines a conversation has entered the scope of an API task. When a user is providing inputs (conversational inputs) that are to be utilized (once resolved and validated) to call a task API, the scope of the data for the task API can include additional context. This additional context can affect the execution of slot resolution and validation workflows for task APIs. The context can also impact intermediate results from SRV workflow because the execution affects how the dialogue manager prompts an end user for a next step.

To contextualize the workflow 600 of FIG. 6, one can return to the examples of transferring points from one user to another. In this example, a user states, to a conversational system, “I want to transfer 1,500 points.” The program code resolves and validates the slot value for this task, transfer_points, by performing a get, specifically, get_number_of_points. Based on resolving and validating the slot, the program code can generate a user prompt (delivered via an AI Assistant), to ask the user, “Whom do you want to transfer to.” The user replies, “To Bob and Jane.” In this example, the dialogue manager called the slot resolution and validation in the SRV flow (e.g., number_of_points) despite having performed the number_of_points validation.

Returning to the workflow 600 of FIG. 6, in this example, a conversational UI router (e.g., FIG. 3, 345) determines if an utterance obtained by the program code is an API task and program code comprising a TODS marks a conversation comprising the utterance as entering API task scope (610). Program code comprising a dialogue manager pre-fills dialogue state and slot values from the utterance and/or dialogue context determined by the program code and sends the slot status to program code comprising an SRV workflow orchestrator (e.g., FIG. 3, 355) (620). Program code comprising the SRV orchestrator determines whether to progress to execution of the workflow or to abandon the existing workflow in progress and start new validation process (630). Program code comprising the SRV orchestrator determines if a new response is a conversational response or UI widget based on builder provided criteria and sends the response schema to a dialogue manager for it to create response for the user (640). In some examples, an SRV orchestrator can call additional task APIs if the program code derived a call from a user utterance (e.g., a user with at least 1,000 points wants to transfer half of those points (500 each) to Bob and Jane).

The examples herein include computer-implemented methods, computer program products and computer system where program code executing on one or more processors resolved and validates data provided to an application programming interface (API) from a conversational system. In some examples, the program code identifies, in a specification for a task API, one or more operations comprising a workflow, where each operation comprises obtaining specific data to fill a slot to call the task API, where a final task of the workflow comprises a call to the task API. The program code generates, for each slot, resolution and validation rules. The program code generates a gateway comprising the resolution and validation rules. Generating the gateway includes the program code connecting the resolution and validation rules to the gateway between the conversational system and a dialogue manager. The program code applies the gateway to resolve each utterance obtained via the conversational system to a slot. In applying the gateway, the program code determines whether to utilize the dialogue manager to generate a prompt to gather a new input or whether to execute the task API.

In some examples, the gateway is a parallel gateway.

In some examples, the program code generates meta-data from the API specification and the program code applies the parallel gateway to resolve each utterance comprises utilizing a conversational user interface of the dialogue manager to map each utterance to the task API.

In some examples, in applying the gateway to resolve each utterance obtained via the conversational system to a slot, the program code generates the new prompt utilizing the meta-data.

In some examples, the program code generates the new prompt comprises by generating a user interface prompt based on an item selected from the group consisting of: an un-fulfilled slot in a schema or a natural language prompt.

In some examples, the program code applying the parallel gateway to resolve each utterance comprises: the program code determining if the utterance is an API task, and based on the program code determining that the utterance is an API task, the program code marking a conversation comprising the utterance as within a scope of the task API.

In some examples, the program code determines a dialogue state for the conversation. The program code pre-fills the dialogue state for each slot based on the utterance. The program code updates a progress indicator for the workflow based on the pre-filling.

In some examples, based on the progress indicator, the program code determines if the slots are filled. Based on determining that the slots are filled, the program code executes the task API.

In some examples, based on the progress indicator, the program code determines if the slots are filled. Based on determining that the slots are not filled, the program code determines a next step.

In some examples, the next step is selected from the group consisting of: sending a response schema to the dialogue manager for it to create response or calling an additional API.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method for resolving and validating data provided to an application programming interface (API) from a conversational system, comprising:
identifying, by one or more processors, in a specification for a task API, one or more operations comprising a workflow, wherein each operation comprises obtaining specific data to fill a slot to call the task API, wherein a final task of the workflow comprises a call to the task API;
generating, by the one or more processors, for each slot, resolution and validation rules;
generating, by the one or more processors, a gateway comprising the resolution and validation rules, wherein the generating the gateway comprises connecting the resolution and validation rules to the gateway between the conversational system and a dialogue manager; and
applying, by the one or more processors, the gateway to resolve each utterance obtained via the conversational system to a slot, wherein the applying comprises determining whether to utilize the dialogue manager to generate a prompt to gather a new input or whether to execute the task API.

2. The computer-implemented method of claim 1, wherein the gateway comprises a parallel gateway.

3. The computer-implemented method of claim 2, further comprising:
generating, by the one or more processors, meta-data from the API specification, wherein applying the parallel gateway to resolve each utterance comprises utilizing a conversational user interface of the dialogue manager to map each utterance to the task API.

4. The computer-implemented method of claim 3, wherein applying the gateway to resolve each utterance obtained via the conversational system to a slot, wherein the applying comprises generating the new prompt, wherein generating the new prompt comprises utilizing the meta-data.

5. The computer-implemented method of claim 4, wherein generating the new prompt comprises generating a user interface prompt based on an item selected from the group consisting of: an un-fulfilled slot in a schema or a natural language prompt.

6. The computer-implemented method of claim 1, wherein applying, the parallel gateway to resolve each utterance comprises:
determining, by the one or more processors, if the utterance is an API task; and
based on determining that the utterance is an API task, marking a conversation comprising the utterance as within a scope of the task API.

7. The computer-implemented method of claim 6, further comprising:
determining, by the one or more processors, a dialogue state for the conversation;
pre-filling, by the one or more processors, the dialogue state for each slot based on the utterance; and
updating, by the one or more processors, a progress indicator for the workflow based on the pre-filling.

8. The computer-implemented method of claim 7, further comprising:
based on the progress indicator, determining, by the one or more processors, if the slots are filled; and
based on determining that the slots are filled, executing the task API.

9. The computer-implemented method of claim 7, further comprising:
based on the progress indicator, determining, by the one or more processors, if the slots are filled; and
based on determining that the slots are not filled, determining a next step.

10. The computer-implemented method of claim 1, wherein the next step is selected from the group consisting of: sending a response schema to the dialogue manager for it to create response or calling an additional API.

11. A computer system for resolving and validating data provided to an application programming interface (API) from a conversational system, the computer system comprising:
a memory; and
one or more processors in communication with the memory, wherein the computer system is configured to perform a method, said method comprising:
identifying, by the one or more processors, in a specification for a task API, one or more operations comprising a workflow, wherein each operation comprises obtaining specific data to fill a slot to call the task API, wherein a final task of the workflow comprises a call to the task API;
generating, by the one or more processors, for each slot, resolution and validation rules;
generating, by the one or more processors, a gateway comprising the resolution and validation rules, wherein the generating the gateway comprises connecting the resolution and validation rules to the gateway between the conversational system and a dialogue manager; and
applying, by the one or more processors, the gateway to resolve each utterance obtained via the conversational system to a slot, wherein the applying comprises determining whether to utilize the dialogue manager to generate a prompt to gather a new input or whether to execute the task API.

12. The computer system of claim 11, wherein the gateway comprises a parallel gateway.

13. The computer system of claim 12, further comprising:
generating, by the one or more processors, meta-data from the API specification, wherein applying the parallel gateway to resolve each utterance comprises utilizing a conversational user interface of the dialogue manager to map each utterance to the task API.

14. The computer system of claim 13, wherein applying the gateway to resolve each utterance obtained via the conversational system to a slot, wherein the applying comprises generating the new prompt, wherein generating the new prompt comprises utilizing the meta-data.

15. The computer system of claim 14, wherein generating the new prompt comprises generating a user interface prompt based on an item selected from the group consisting of: an un-fulfilled slot in a schema or a natural language prompt.

16. The computer system of claim 11, wherein applying, the parallel gateway to resolve each utterance comprises:
determining, by the one or more processors, if the utterance is an API task; and
based on determining that the utterance is an API task, marking a conversation comprising the utterance as within a scope of the task API.

17. The computer system of claim 16, the method further comprising:
determining, by the one or more processors, a dialogue state for the conversation;
pre-filling, by the one or more processors, the dialogue state for each slot based on the utterance; and
updating, by the one or more processors, a progress indicator for the workflow based on the pre-filling.

18. The computer system of claim 17, the method further comprising:
based on the progress indicator, determining, by the one or more processors, if the slots are filled; and
based on determining that the slots are filled, executing the task API.

19. The computer system of claim 17, the method further comprising:
based on the progress indicator, determining, by the one or more processors, if the slots are filled; and
based on determining that the slots are not filled, determining a next step.

20. A computer program product for resolving and validating data provided to an application programming interface (API) from a conversational system, the computer system comprising:
one or more computer readable storage media and program instructions collectively stored on the one or more computer readable storage media readable by at least one processing circuit to:
identify in a specification for a task API, one or more operations comprising a workflow, wherein each operation comprises obtaining specific data to fill a slot to call the task API, wherein a final task of the workflow comprises a call to the task API;
generate, for each slot, resolution and validation rules;
generate a gateway comprising the resolution and validation rules, wherein the generating the gateway comprises connecting the resolution and validation rules to the gateway between the conversational system and a dialogue manager; and
apply the gateway to resolve each utterance obtained via the conversational system to a slot, wherein the applying comprises determining whether to utilize the dialogue manager to generate a prompt to gather a new input or whether to execute the task API.
